(19) United States
(12) Patent Application Publication
(10) Pub. No.: US 2025/0039905 A1
(43) Pub. Date: Jan. 30, 2025

(54) SUPPORTING MULTICAST OR BROADCAST OPERATIONS WITH ENHANCED REDUCED CAPACITY USER EQUIPMENT

(71) Applicant: QUALCOMM Incorporated, San Diego, CA (US)

(72) Inventors: Yi HUANG, San Diego, CA (US); Le LIU, San Jose, CA (US)

(21) Appl. No.: 18/774,212

(22) Filed: Jul. 16, 2024

Related U.S. Application Data
(60) Provisional application No. 63/515,509, filed on Jul. 25, 2023.

(51) Int. Cl. H04W 72/30; H04L 1/1812; H04W 72/0446; H04W 72/0457

(52) U.S. Cl. CPC H04W 72/30; H04L 1/1812; H04W 72/0446; H04W 72/0457

(57) ABSTRACT

Methods, systems, and devices for wireless communications are described. A user equipment (UE) may receive control information that schedules a multicast traffic channel transmission and that indicates a bandwidth of the transmission. The UE may receive, in accordance with the control information, one or more instances of the transmission, where a quantity of the one or more instances is based at least in part on the bandwidth of the transmission. Additionally, or alternatively, the UE may receive control information that schedules a multicast traffic channel transmission and that indicates whether the UE is to transmit an acknowledgement in response to the transmission. The UE may receive, in accordance with the control information, the transmission, where the multicast traffic channel transmission is received over a bandwidth that is based at least in part on whether the UE is to transmit the acknowledgement in response to the multicast traffic channel transmission.

### CROSS REFERENCE

The present Application for Patent claims the benefit of U.S. Provisional Patent Application No. 63/515,509 by HUANG et al., entitled “SUPPORTING MULTICAST OR BROADCAST OPERATIONS WITH ENHANCED REDUCED CAPACITY USER EQUIPMENT,” filed Jul. 25, 2023, assigned to the assignee hereof, and expressly incorporated by reference herein.

### TECHNICAL FIELD

The following relates to wireless communications, including support for multicast or broadcast operations with enhanced reduced capacity user equipment.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a wireless device may be a reduced capability device and may communicate within the wireless communications system. However, such approaches may be improved.

### SUMMARY

The described techniques relate to improved methods, systems, devices, and apparatuses that support multicast or broadcast operations with enhanced reduced capacity user equipment. For example, a user equipment (UE) may receive control information that schedules a multicast traffic channel transmission and that indicates a bandwidth of the transmission. The UE may receive, in accordance with the control information, one or more instances of the transmission, where a quantity of the one or more instances is based at least in part on the bandwidth of the transmission. Additionally, or alternatively, the UE may receive control information that schedules a multicast traffic channel transmission and that indicates whether the UE is to transmit an acknowledgement in response to the transmission. The UE may receive, in accordance with the control information, the transmission, where the multicast traffic channel transmission is received over a bandwidth that is based at least in part on whether the UE is to transmit the acknowledgement in response to the multicast traffic channel transmission.

A method for wireless communications by a UE is described. The method may include receiving control information that schedules a broadcast transmission and that indicates a bandwidth of the broadcast transmission and receiving, in accordance with the control information, one or more instances, in multiple time slots, of the broadcast transmission, where a quantity of the one or more instances is associated with the bandwidth of the broadcast transmission.

A UE for wireless communications is described. The UE may include one or more memories storing processor executable code, and one or more processors coupled with the one or more memories. The one or more processors may individually or collectively operable to execute the code to cause the UE to receive control information that schedules a broadcast transmission and that indicates a bandwidth of the broadcast transmission and receive, in accordance with the control information, one or more instances, in multiple time slots, of the broadcast transmission, where a quantity of the one or more instances is associated with the bandwidth of the broadcast transmission.

Another UE for wireless communications is described. The UE may include means for receiving control information that schedules a broadcast transmission and that indicates a bandwidth of the broadcast transmission and means for receiving, in accordance with the control information, one or more instances, in multiple time slots, of the broadcast transmission, where a quantity of the one or more instances is associated with the bandwidth of the broadcast transmission.

A non-transitory computer-readable medium storing code for wireless communications is described. The code may include instructions executable by a processor (e.g., directly, indirectly, after pre-processing, without pre-processing) to receive control information that schedules a broadcast transmission and that indicates a bandwidth of the broadcast transmission and receive, in accordance with the control information, one or more instances, in multiple time slots, of the broadcast transmission, where a quantity of the one or more instances is associated with the bandwidth of the broadcast transmission.

In some examples of the method, UEs, and non-transitory computer-readable medium described herein, the bandwidth of the broadcast transmission being greater than a bandwidth threshold may be associated with the quantity of the one or more instances being one, and the bandwidth of the broadcast transmission being less than the bandwidth threshold may be associated with the quantity of the one or more instances being two or more.

In some examples of the method, UEs, and non-transitory computer-readable medium described herein, the bandwidth threshold may be 5 MHz.

In some examples of the method, UEs, and non-transitory computer-readable medium described herein, the bandwidth threshold may be based on 25 physical resource blocks and a subcarrier spacing of 15 kHz or 12 physical resource blocks and a subcarrier spacing of 30 kHz.

In some examples of the method, UEs, and non-transitory computer-readable medium described herein, the bandwidth of the broadcast transmission may indicate the quantity of the one or more instances to be processed by the UE.

In examples of the method, UEs, and non-transitory computer-readable medium described herein, the bandwidth of the broadcast transmission may be less than a bandwidth threshold, and the one or more instances may include multiple instances based on the bandwidth of the broadcast transmission being less than the bandwidth threshold. In such cases, the method, UEs, and non-transitory computer-readable medium described herein may further include operations, features, means, or instructions for processing the multiple instances based on the bandwidth of the broadcast transmission being less than the bandwidth threshold.

Some examples of the method, UEs, and non-transitory computer-readable medium described herein may further include operations, features, means, or instructions for determining the quantity of the one or more instances of the broadcast transmission based on a comparison of the bandwidth of the broadcast transmission with a set of multiple bandwidth thresholds, where each bandwidth threshold may be associated with a respective quantity of supported instances.

In some examples of the method, UEs, and non-transitory computer-readable medium described herein, determining the quantity of the one or more instances of the broadcast transmission may include operations, features, means, or instructions for determining that a first bandwidth threshold of the set of multiple bandwidth thresholds may be a largest bandwidth threshold satisfied by the bandwidth of the broadcast transmission and determining the quantity of the one or more instances of the broadcast transmission to be the respective quantity of supported instances associated with the first bandwidth threshold.

In some examples of the method, UEs, and non-transitory computer-readable medium described herein, the set of multiple supported instance quantities may be inversely correlated with the set of multiple bandwidth thresholds.

In some examples of the method, UEs, and non-transitory computer-readable medium described herein, one of the set of multiple bandwidth thresholds may be 5 megahertz (MHz).

In some examples of the method, UEs, and non-transitory computer-readable medium described herein, the control information may be included in downlink control information signaling.

In some examples of the method, UEs, and non-transitory computer-readable medium described herein, the multiple time slots may be consecutive time slots or non-consecutive time slots.

A method for wireless communications by a UE is described. The method may include receiving control information that schedules a multicast traffic channel transmission and that indicates whether the UE is to transmit an acknowledgement in response to the multicast traffic channel transmission and receiving, in accordance with the control information, the multicast traffic channel transmission, where the multicast traffic channel transmission is received over a bandwidth that is based on whether the UE is to transmit the acknowledgement in response to the multicast traffic channel transmission.

A UE for wireless communications is described. The UE may include one or more memories storing processor executable code, and one or more processors coupled with the one or more memories. The one or more processors may individually or collectively operable to execute the code to cause the UE to receive control information that schedules a multicast traffic channel transmission and that indicates whether the UE is to transmit an acknowledgement in response to the multicast traffic channel transmission and receive, in accordance with the control information, the multicast traffic channel transmission, where the multicast traffic channel transmission is received over a bandwidth that is based on whether the UE is to transmit the acknowledgement in response to the multicast traffic channel transmission.

Another UE for wireless communications is described. The UE may include means for receiving control information that schedules a multicast traffic channel transmission and that indicates whether the UE is to transmit an acknowledgement in response to the multicast traffic channel transmission and means for receiving, in accordance with the control information, the multicast traffic channel transmission, where the multicast traffic channel transmission is received over a bandwidth that is based on whether the UE is to transmit the acknowledgement in response to the multicast traffic channel transmission.

A non-transitory computer-readable medium storing code for wireless communications is described. The code may include instructions executable by a processor (e.g., directly, indirectly, after pre-processing, without pre-processing) to receive control information that schedules a multicast traffic channel transmission and that indicates whether the UE is to transmit an acknowledgement in response to the multicast traffic channel transmission and receive, in accordance with the control information, the multicast traffic channel transmission, where the multicast traffic channel transmission is received over a bandwidth that is based on whether the UE is to transmit the acknowledgement in response to the multicast traffic channel transmission.

Some examples of the method, UEs, and non-transitory computer-readable medium described herein may further include operations, features, means, or instructions for determining that the bandwidth of the multicast traffic channel transmission may be not permitted to exceed a bandwidth threshold based on the control information indicating that the UE may be to transmit the acknowledgement in response to the multicast traffic channel transmission.

In some examples of the method, UEs, and non-transitory computer-readable medium described herein, the bandwidth threshold may be 5 MHz.

Some examples of the method, UEs, and non-transitory computer-readable medium described herein may further include operations, features, means, or instructions for determining that the bandwidth of the multicast traffic channel transmission may be permitted to exceed a bandwidth threshold based on the control information indicating that the UE may be not to transmit the acknowledgement in response to the multicast traffic channel transmission.

In some examples of the method, UEs, and non-transitory computer-readable medium described herein, the bandwidth threshold may be 5 MHz.

Some examples of the method, UEs, and non-transitory computer-readable medium described herein may further include operations, features, means, or instructions for determining that the bandwidth of the multicast traffic channel transmission may be permitted to exceed a bandwidth threshold based on the control information indicating that the UE may be to transmit the acknowledgement in response to the multicast traffic channel transmission and the control information scheduling second resources for the UE to transmit the acknowledgement that may be later in time than first resources scheduled for feedback transmission when the bandwidth of the multicast traffic channel transmission may be less than the bandwidth threshold.

In some examples of the method, UEs, and non-transitory computer-readable medium described herein, the control information indicates whether the UE may be to transmit an acknowledgement in response to the multicast traffic channel transmission based on an identifier associated with the UE.

In some examples of the method, UEs, and non-transitory computer-readable medium described herein, the acknowledgement may be hybrid automatic repeat request acknowledgement feedback.

In some examples of the method, UEs, and non-transitory computer-readable medium described herein, the UE may be operating in a connected mode.

In some examples of the method, UEs, and non-transitory computer-readable medium described herein, the control information may be included in downlink control information signaling, radio resource control signaling, or both.

### BRIEF DESCRIPTION OF THE DRAWINGS

FIG. 1 shows an example of a wireless communications system that supports multicast or broadcast operations with enhanced reduced capacity user equipment in accordance with one or more examples as disclosed herein.

FIG. 2 shows an example of a wireless communications system that supports multicast or broadcast operations with enhanced reduced capacity user equipment in accordance with one or more examples as disclosed herein.

FIGS. 3A and 3B show examples of multicast/broadcast (MBS) schemes that support multicast or broadcast operations with enhanced reduced capacity user equipment in accordance with one or more examples as disclosed herein.

FIG. 4 shows an example of a process flow that supports multicast or broadcast operations with enhanced reduced capacity user equipment in accordance with one or more examples as disclosed herein.

FIG. 5 shows an example of a process flow that supports multicast or broadcast operations with enhanced reduced capacity user equipment in accordance with one or more examples as disclosed herein.

FIGS. 6 and 7 show block diagrams of devices that support multicast or broadcast operations with enhanced reduced capacity user equipment in accordance with one or more examples as disclosed herein.

FIG. 8 shows a block diagram of a communications manager that supports multicast or broadcast operations with enhanced reduced capacity user equipment in accordance with one or more examples as disclosed herein.

FIG. 9 shows a diagram of a system including a device that supports multicast or broadcast operations with enhanced reduced capacity user equipment in accordance with one or more examples as disclosed herein.

FIGS. 10 and 11 show flowcharts illustrating methods that support multicast or broadcast operations with enhanced reduced capacity user equipment in accordance with one or more examples as disclosed herein.

### DETAILED DESCRIPTION

In wireless communications, it may be desirable to use devices that have reduced capacities that may offer reduced power consumption (e.g., for long-term deployments or other situations that benefit from reduced power consumption). Such devices may include reduced capability (RedCap) user equipments (UEs) or enhanced reduced capability (eRedCap) UEs, which may include various reduced capabilities, such as reduced bandwidth handling capabilities. However, some approaches for wireless communications may not consider multicast/broadcast (MBS) scenarios for such UEs. For example, some approaches may limit transmissions to a strict maximum bandwidth, may not allow repetitions of such transmissions, or may not accommodate feedback scenarios. Further, current wireless communications standards may not consider the use of eRedCap UEs in the context of MBS communications. As such, improvements to RedCap and eRedCap wireless communications may be desirable.

In some implementations, a quantity of allowed repetitions of an MBS transmission may be associated with a bandwidth of the MBS transmission. For example, a network entity may indicate a bandwidth of the MBS transmission and the UE may implicitly determine that a quantity of repetitions of the MBS transmission may be transmitted by the network entity. For example, if the bandwidth of the MBS transmission is relatively low, then the UE, despite its reduced capability, may be able to receive or process the repetitions. In contrast, if the bandwidth of the MBS transmission is relatively high, then the UE may not be able to receive or process the repetitions, in which case the quantity of repetitions may be reduced (in some cases, to a single transmission). In this way, the wireless communications system may improve the utilization of the reduced capabilities of the UE, offering improved communications quality and reliability.

Further, in some implementations, a bandwidth of an MBS transmission may be based on whether the UE is to provide acknowledgement feedback in response to the MBS transmission. For example, if the UE is signaled to provide acknowledgement feedback to the MBS transmission, then the UE may implicitly determine that the MBS transmission will not exceed a bandwidth threshold, as both receiving a larger bandwidth communication and providing timely feedback may not be within the capabilities of the UE. Similarly, if the UE is not signaled to provide acknowledgement feedback to the MBS transmission, then the UE may implicitly determine that the MBS transmission is allowed to exceed the bandwidth threshold. In this way, the wireless communications system may improve the utilization of the reduced capabilities of the UE, offering improved communications quality and reliability.

Aspects of the disclosure are initially described in the context of wireless communications systems. Aspects of the disclosure are then described with reference to a wireless communications system, MBS schemes, and process flows. Aspects of the disclosure are further illustrated by and described with reference to apparatus diagrams, system diagrams, and flowcharts that relate to multicast or broadcast operations with enhanced reduced capacity user equipment.

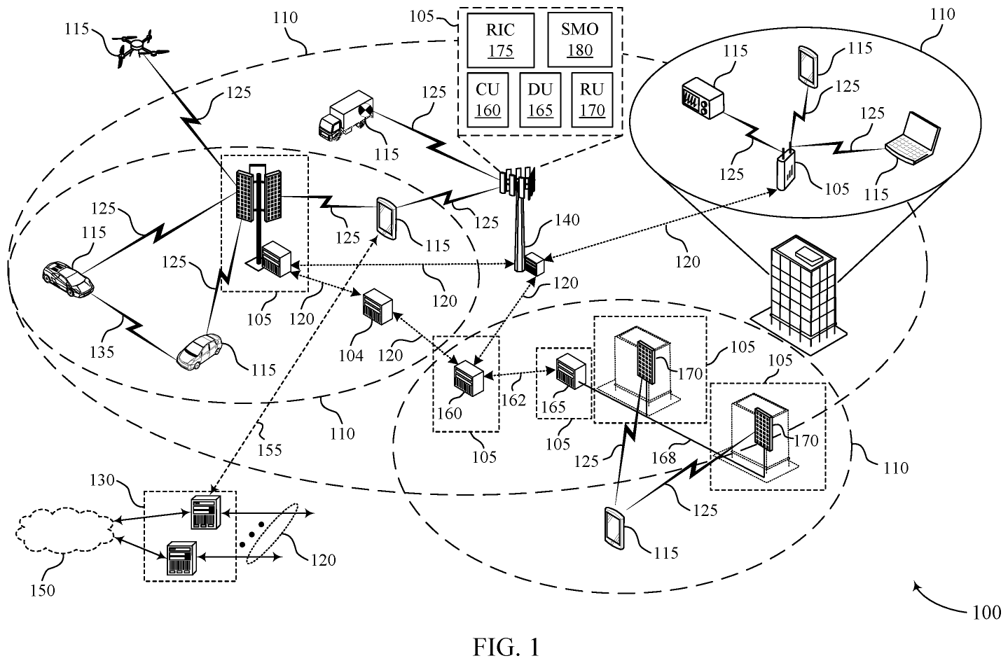

FIG. 1 shows an example of a wireless communications system 100 that supports multicast or broadcast operations with enhanced reduced capacity user equipment in accordance with one or more examples as disclosed herein. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support multicast or broadcast operations with enhanced reduced capacity user equipment as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (cMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 MHz to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, a UE 115 and a network entity 105 may support one or more signaling-or configuration-based mechanisms according to which the UE 115 and the network entity 105 (e.g., a RedCap UE or an eRedCap UE) may support MBS communications. For example, the UE 115 may receive an indication from the network entity 105 that indicates a bandwidth of an upcoming MTCH transmission (e.g., an MBS transmission, broadcast traffic channel transmission). Based on this control signaling (and more specifically, the indicated bandwidth), the UE may determine whether the UE 115 is to receive multiple instances (e.g., repetitions) of the MTCH transmission. For example, the network entity 105 may transmit a single instance of the MBS transmission if the bandwidth of the MTCH transmission is large (e.g., exceeds a threshold) or may transmit multiple instances of the MTCH transmission if the bandwidth of the MTCH transmission is small (e.g., does not exceed a threshold). Additionally, or alternatively, the control signaling may indicate whether the UE 115 is to provide an acknowledgement to the MTCH transmission. Based on this indication, the UE 115 may determine a bandwidth of the MTCH transmission. For example, if the UE 115 is to provide the acknowledgement, the UE 115 may determine that the bandwidth of the MTCH transmission is to be small (e.g., below a threshold) to accommodate the acknowledgement. Similarly, if the UE 115 is not to provide the acknowledgement, the UE 115 may determine that the bandwidth of the MTCH transmission is allowed to be large (e.g., above a threshold) as the UE 115 may not need to accommodate an acknowledgement.

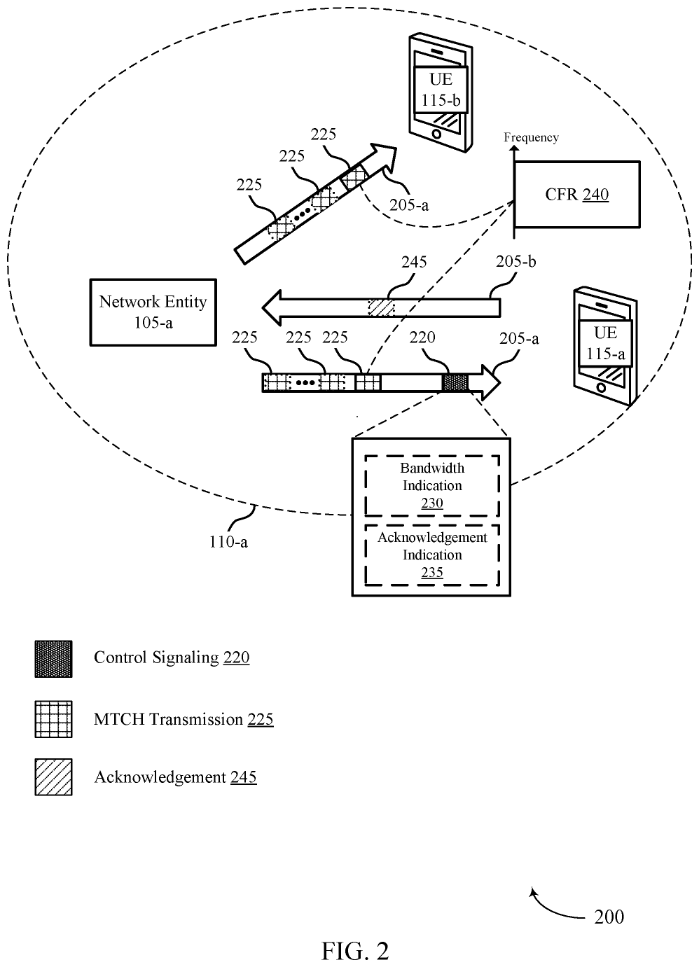

FIG. 2 shows an example of a wireless communications system 200 that supports multicast or broadcast operations with enhanced reduced capacity user equipment in accordance with one or more examples as disclosed herein. The wireless communications system 200 may include the network entity 105-a, which may be an example of one or more network entities discussed in relation to other figures. The wireless communications system 200 may include the UE 115-a, which may be an example of UEs discussed in relation to other figures. The wireless communications system 200 may include the UE 115-b, which may be an example of UEs discussed in relation to other figures.

In some examples, the UE 115-a may be located in a geographic coverage area 110-a that may be associated with the network entity 105-a. The network entity 105-a and UE 115-a may communicate via one or more downlink communication links 205-a and one or more uplink communication links 205-b.

In wireless communications, some UEs may have reduced capabilities and may be referred to as RedCap UEs. The UE 115-b is one example of such a RedCap UE. Some UEs may have “enhanced” reduced capabilities (e.g., further reduced capabilities) and may be referred to as eRedCap UEs. The UE 115-a is one example of an eRedCap UE. For example, a RedCap UE may operate with a reduced bandwidth (e.g., as compared to a non-RedCap UE) for some communications (e.g., with the network entity 105-a). In some approaches, eRedCap UEs (e.g., the UE 115-a) may further reduce baseband bandwidth capabilities as compared to RedCap UEs for some communications (e.g., with the network entity 105-a). In some examples, an eRedCap UE (e.g., the UE 115-a) may operate with a PUSCH bandwidth that may not exceed a bandwidth threshold (e.g., 5 MHz) (e.g., an arrangement of 25 physical resource blocks (PRBs) with 15 kHz subcarrier spacing (SCS), 12 PRBs with 30 kHz SCS, or another arrangement of PRBs, SCSs, or both). In some examples, an eRedCap UE (e.g., the UE 115-a) may operate with a unicast physical downlink shared channel (PDSCH) bandwidth that may not exceed a bandwidth threshold (e.g., 5 MHz) (e.g., 25 PRBs with 15 kHz SCS, 12 PRBs with 30 kHz SCS, or other arrangements of PRBs, SCSs, or both). However, in some cases, some communications may exceed such a bandwidth threshold. For example, in some cases, a broadcast PDSCH transmission (e.g., one or more system information block (SIB) transmissions, a paging transmission, a random access response transmission, one or more other transmissions, or any combination thereof) may be of a bandwidth exceeding a bandwidth threshold (e.g., 5 MHz) (e.g., 25 PRBs with 15 kHz SCS, 12 PRBs with 30 kHz SCS, or other arrangements of PRBs, SCSs, or both). In some examples, other transmissions, such as SSB transmissions, TRS transmissions, CSI-RS transmissions, SRS transmissions, PDCCH transmissions, PUCCH transmissions or channels, or any combination thereof, may be of a bandwidth exceeding a bandwidth threshold (e.g., 5 MHz).

In some examples of broadcast communication scenarios, a multicast control channel (MCCH) or multicast traffic channel (MTCH) transmission (e.g., the MTCH transmission 225) may be received by UEs (e.g., the UE 115-a, the UE 115-b or both) in idle, inactive, or connected states. In some examples, one broadcast common frequency resource (CFR), such as the CFR 240, may be configured (e.g., by a system information block transmission, such as SIB20) for MCCH transmissions, MTCH transmissions (e.g., the MTCH transmission 225), or both. In some examples, control signaling (e.g., DCI, such as DCI format 4_0, which may be configured in Type 0/0B common search space (CSS)) may be used to schedule MCCH transmissions, MTCH transmissions (e.g., the MTCH transmission 225), or both. In some examples, semi-static or dynamic slot-level (e.g., back-to-back) repetition (e.g., using multiple instances of a message or transmission) for broadcast MTCH transmissions (e.g., the MTCH transmission 225) may be allowed. In some examples, one or more parameters (e.g., a pdsch-AggregationFactor) may be configured (e.g., on a per G-RNTI basis) via control signaling (e.g., SIB20) for semi-static repetition of broadcast MTCH transmissions (e.g., the MTCH transmission 225). In some examples, one or more parameters (e.g., a repetitionNumber parameter in a time domain resource allocation (TDRA) table) may be configured for dynamic repetition of broadcast MTCH transmissions (e.g., the MTCH transmission 225). In some examples, feedback (e.g., HARQ-ACK feedback) may not supported for broadcast MCCH transmissions, MTCH transmissions (e.g., the MTCH transmission 225), or both. However, in other examples, feedback (e.g., HARQ-ACK feedback) may be supported for broadcast MCCH transmissions, MTCH transmissions (e.g., the MTCH transmission 225), or both.

In some examples of multicast communication scenarios, a UE (e.g., the UE 115-a, the UE 115-b or both) may receive multicast MTCH transmissions (e.g., the MTCH transmission 225) while the UE (e.g., the UE 115-a, the UE 115-b or both) is in an RRC_CONNECTED state. In some examples, one multicast CFR, such as the CFR 240, may be configured (e.g., via unicast RRC signaling or other control signaling) for multicast MTCH transmissions (e.g., the MTCH transmission 225) on a per-DL BWP basis can be configured via unicast RRC signaling. In some examples, a UE (e.g., the UE 115-a, the UE 115-b or both) may receive control signaling (e.g., DCI signaling, such as DCI format 4_1 or 4-2 (e.g., configured in Type3 CSS) that may schedule one or more multicast MTCH transmissions (e.g., the MTCH transmission 225). In some examples, semi-static or dynamic slot-level (e.g., back-to-back) repetition (e.g., transmission of multiple instances of a transmission or message) for multicast MTCH transmissions (e.g., the MTCH transmission 225) is allowed. In some examples, semi-static or dynamic enabling or disabling of feedback messaging (e.g., HARQ-ACK feedback) for multicast MTCH transmissions (e.g., the MTCH transmission 225) may be employed. In some examples in which HARQ-ACK feedback is enabled for multicast, feedback (e.g., the acknowledgement 245) may be provided using at least two feedback modes. A first feedback scheme may involve transmission of both positive acknowledgements (ACKs) in response to successful receipt and/or decoding of a message (e.g., the MTCH transmission 225) and negative acknowledgements (NACKs) in response to unsuccessful receipt and/or decoding of a message (e.g., the MTCH transmission 225). A second scheme may be a NACK-only scheme in which the UE 115-a does not transmit an ACK in response to successful receipt and/or decoding of a message but the UE 115-a transmits a NACK in response to an unsuccessful receipt and/or decoding of a message.

In some examples, some modifications to broadcast transmission scenarios may be employed. For example, a single CFR (e.g., the CFR 240) may be used for both RedCap UEs (e.g., the UE 115-b) and eRedCap UEs (e.g., the UE 115-a). Such a CFR may be no larger than a bandwidth threshold (e.g., 20 MHz) and may be configured by control signaling (e.g., a system information broadcast, such as a SIB20 message). Such a CFR may utilize resources that are at least partially different from resources used in connection with non-RedCap UEs.

In some examples, some modifications to multicast transmission scenarios may be employed. For example, multicast MCCH transmissions, multicast MTCH transmissions, or both, may be received by UEs (e.g., the UE 115-a, the UE 115-b or both) in an inactive state (e.g., an RRC_INACTIVE state). In some examples, a single CFR (e.g., the CFR 240) may be configured for multicast transmissions. Such a CFR may be configured via control signaling, such as system information block signaling. In some examples, control signaling (e.g., DCI signaling, such as DCI format 4_0) may be configured (e.g., in Type0/OB CSS) and used for multicast MCCH transmissions to be received by a UE in an inactive state (e.g., RRC_INACTIVE). In some examples, control signaling (e.g., DCI signaling, such as DCI format 4_1) may be configured (e.g., in Type3-CSS) is used to schedule multicast MTCH transmissions to be received by a UE in an inactive state (e.g., RRC_INACTIVE). In some examples, semi-static or dynamic slot-level (e.g., back-to-back) repetition for multicast MTCH transmissions may be permitted. In some examples, feedback transmissions responding to a multicast MTCH transmission, a multicast MCCH transmission, or both, may not be supported while the UE is in an inactive mode (e.g., RRC_INACTIVE).

In some examples, both RedCap UEs (e.g., the UE 115-b) and eRedCap UEs (e.g., the UE 115-a) may treat an MBS transmission (e.g., a broadcast transmission, a multicast transmission, or both), such as the MTCH transmission 225, as a transmission that may be allowed to use a bandwidth that is above a bandwidth threshold (e.g., 5 MHz) (e.g., a SIB transmission, a paging transmission, or a random access response message). In some examples, both RedCap UEs (e.g., the UE 115-b) and eRedCap UEs (e.g., the UE 115-a may share the CFR 240 for communication of MCCH transmissions, MTCH transmissions (e.g., the MTCH transmission 225), or both, as indicated by control signaling (e.g., a system information block transmission, such as SIB20). As the CFR 240 may be shared between RedCap UEs and eRedCap UEs, a device transmitting a PDSCH transmission (e.g., the network entity 105-a) may not distinguish between transmitting to RedCap UEs (e.g., the UE 115-b) and eRedCap UEs (e.g., the UE 115-a). Additionally, or alternatively, a device transmitting a PDSCH transmission (e.g., the network entity 105-a) may not distinguish between transmitting to RedCap UEs (e.g., the UE 115-b) and RedCap UEs (e.g., the UE 115-a) that are operating in an inactive mode (e.g., an RRC_INACTIVE mode or state). In some examples, the CFR 240 may be used for broadcast transmissions (e.g., broadcast traffic channel transmission, broadcast channel transmission), multicast transmissions (e.g., multicast traffic channel transmission, multicast channel transmission), or both. Operations described herein relating to broadcast transmissions apply equally to multicast transmissions, and operations described herein relating to multicast transmissions apply equally to broadcast transmissions.

In some examples, even if the UE 115-a is to provide the acknowledgement 245 (e.g., the acknowledgement indication 235 is included in the control signaling 220 or the acknowledgement indication 235 indicates that the UE 115-a is to provide the acknowledgement 245), the bandwidth of the MTCH transmission 225 may be allowed to exceed the bandwidth threshold. However, in some such cases, the network entity 105-a may provide extra time for the UE 115-a to provide the acknowledgement 245 (e.g., because the UE 115-a needs additional time to both receive, decode, or process the MTCH transmission 225 and provide the acknowledgement 245, given its characteristics as an eRedCap UE).

In some examples, the UE 115-a (being an eRedCap UE) may include a capability to receive a broadcast transmission, such as the MTCH transmission 225 (e.g., broadcast traffic channel transmission), that has a bandwidth greater than a bandwidth threshold (e.g., 5 MHz). However, in some cases, the UE 115-a may not include a capability to receive such a transmission on back-to-back slots. In some examples, repetition of the MTCH transmission 225, an MCCH transmission, or both, may be disallowed for the UE 115-a, other eRedCap UEs, or both. For example, the depicted optional instances of the MTCH transmission 225 may not be transmitted. In some examples, such a scheme may also be implemented for RedCap UEs, non-RedCap UEs, or both. Additionally, or alternatively, RedCap UEs, non-RedCap UEs, or both may receive repetition or additional instances of the MTCH transmission 225 even though cRedCap UEs may not receive repetitions or additional instances of the MTCH transmission 225. Such approaches may apply equally if the MTCH transmission 225 is a broadcast transmission or a multicast transmission. For example, repetition may be disallowed (e.g., disabled) for a multicast MCCH transmission, a multicast MTCH transmission 225, or both.

Additionally, or alternatively, repetition of an MCCH transmission may be disallowed, while transmission of repetitions or additional instances of the MTCH transmission 225 may be allowed based on an indicated bandwidth of the MTCH transmission 225. For example, the network entity 105-a may transmit the control signaling 220 to the UE 115-a and the control signaling 220 may include a bandwidth indication 230 that may indicate the bandwidth of the MTCH transmission 225. The bandwidth of the MTCH transmission 225 indicated in the bandwidth indication 230 may be the same bandwidth of that which is associated with the CFR 240 for eRedCap UEs or it may be a different bandwidth.

Such approaches may apply equally if the MTCH transmission 225 is a broadcast transmission or a multicast transmission. For example, repetition of a multicast MCCH transmission for eRedCap UEs (e.g., the UE 115-a) in an inactive mode or state (e.g., an RRC_INACTIVE mode or state) or an active or connected mode or state (e.g., an RRC_CONNECTED mode or state) may be disallowed, while transmission of repetitions or additional instances of the multicast MTCH transmission 225 may be allowed for eRedCap UEs (e.g., the UE 115-a) in an inactive mode or state (e.g., an RRC_INACTIVE mode or state) or an active or connected mode or state (e.g., an RRC_CONNECTED mode or state) based on an indicated bandwidth of the MTCH transmission 225.

In some examples, a quantity of repetitions or instances of the MTCH transmission 225 may be associated with (e.g., depend upon or may be based on) the bandwidth indicated in the bandwidth indication 230, and may further be based on a sliding scale between the bandwidth of the MTCH transmission 225 and the quantity of repetitions or instances. That is, the bandwidth indicated in the bandwidth indication 230 may be based on the quantity of repetitions or instances of the MTCH transmission. In some examples, the bandwidth and the quantity of repetitions or instances may be inversely correlated. For example, a higher bandwidth may result in fewer or no repetitions or instances, and a lower bandwidth may result in a greater quantity of repetitions or instances. Such approaches may apply equally if the MTCH transmission 225 is a broadcast transmission or a multicast transmission (e.g., which may include situations in which the UE 115-a is in an inactive mode or state (e.g., an RRC_INACTIVE mode or state) or an active or connected mode or state (e.g., an RRC_CONNECTED mode or state)).

For example, if the bandwidth of the MTCH transmission 225 is less than a first bandwidth threshold (e.g., 5 MHz), the network entity 105-a may transmit up to a quantity of repetitions or instances (e.g., 16 repetitions or instances) of the MTCH transmission 225 for eRedCap UEs (same as RedCap and nonRedCap UEs). Further, if the bandwidth of broadcast MTCH for eRedCap is greater than the first bandwidth threshold (e.g., 5 MHz) and less than a second bandwidth threshold (e.g., 10 MHz), the network entity 105-a may transmit fewer repetitions or instances (e.g., up to eight repetitions or instances) of the MTCH transmission 225 for eRedCap UEs. Further, if the bandwidth of the MTCH transmission is greater than the second bandwidth threshold (e.g., 10 MHz) and less than a third bandwidth threshold (e.g., 20 MHz), the network entity 105-a may transmit yet fewer repetitions or instances (e.g., up to four repetitions or instances) of the MTCH transmission 225 for eRedCap UEs. Further, if the bandwidth of the MTCH transmission 225 is greater than the third bandwidth threshold (e.g., 20 MHz), the network entity 105-a may not transmit any additional repetitions or instances of the MTCH transmission 225 (e.g., may disallow repetition) for the MTCH transmission 225. Again, such approaches may apply equally if the MTCH transmission 225 is a broadcast transmission or a multicast transmission. In some examples in which multiple repetitions or instances are transmitted, the multiple repetitions or instances may be transmitted in back-to-back or consecutive slots, or may be transmitted in non-back-to-back or non-consecutive slots, or a combination thereof.

Such schemes may apply equally to both multicast transmissions and broadcast transmissions. For example, the scheme discussed above with multiple thresholds and different quantities of repetitions or instances of the MTCH transmission 225 may apply equally to broadcast transmissions and multicast transmissions, including multicast transmissions in which the UE 115-a is operating in an inactive mode or state (e.g., an RRC_INACTIVE mode or state) or an active or connected mode or state (e.g., an RRC_CONNECTED mode or state).

In some examples, the UE 115-a (and, optionally, the UE 115-b) may operate in a connection mode or state (e.g., RRC_CONNECTED) and the CFR 240 may be configured for use by the UE 115-a (and, optionally, the UE 115-b) via control signaling (e.g., control signaling 220 or other control signaling). In some examples, the network entity 105-a may allow or disallow a bandwidth of the MTCH transmission 225 that is greater than a bandwidth threshold (e.g., 5 MHz) based on whether the UE 115-a is to provide feedback or acknowledgements (e.g., the acknowledgement indication 235 is included in the control signaling 220 or the acknowledgement indication 235 indicates that the UE 115-a is to provide the acknowledgement 245, which may be an ACK, a NACK, or other feedback or acknowledgement) associated with the MTCH transmission 225. For example, if the UE 115-a is to provide the acknowledgement 245, the network entity 105-a may not transmit the MTCH transmission 225 over a bandwidth greater than the bandwidth threshold. Similarly, if the UE 115-a is not instructed to provide the acknowledgement 245 (e.g., the acknowledgement indication 235 is not included in the control signaling 220 or the acknowledgement indication 235 indicates that the UE 115-a is not to provide the acknowledgement 245, the network entity 105-a may transmit the MTCH transmission 225 over a bandwidth that is greater than the bandwidth threshold. The UE 115-a may also make a determination as to the expected bandwidth of the MTCH transmission 225. For example, if the UE 115-a is to provide the acknowledgement 245, the UE 115-a may determine that the MTCH transmission 225 is not permitted to be transmitted over a bandwidth greater than the bandwidth threshold. Similarly, if the UE 115-a is not instructed to provide the acknowledgement 245, the UE 115-a may determine that the MTCH transmission 225 is permitted to be transmitted over a bandwidth greater than the bandwidth threshold. In some examples, the instructions to the UE 115-a to provide or to not provide the acknowledgement 245 may be provided on one or more different bases. For example, the enabling or disabling of the acknowledgement 245 may be provided on a per-identifier basis (e.g., a group radio network temporary identifier (G_RNTI), a group-configured scheduled radio network temporary identifier (G-CS_RNTI), one or more other identifiers, or any combination thereof).

In some examples, the UE 115-a (and, optionally, the UE 115-b) may operate in a connected mode or state (e.g., RRC_CONNECTED). In such a scenario, operations involving multiple repetitions or instances of the MTCH transmission 225 transmitted by the network entity 105-a may be modified. For example, if the UE 115-a is to provide the acknowledgement 245 (which, in turn, may disallow transmission of a MTCH transmission 225 being transmitted over a bandwidth that is greater than a bandwidth threshold, such as 5 MHz), the use of multiple repetitions or instances may be supported for transmissions to the UE 115-a (e.g., in a manner similar to the use of multiple repetitions or instances in unicast scenarios involving the UE 115-a). However, if the UE 115-a is not to provide the acknowledgement 245 (e.g., which may allow transmission of a MTCH transmission 225 being transmitted over a bandwidth that is greater than a bandwidth threshold, such as 5 MHz), the use of multiple repetitions or instances of the MTCH transmission 225 may either be disallowed or the quantity of repetitions or instances of the MTCH transmission 225 transmitted by the network entity 105-a may depend on a bandwidth of the MTCH transmission 225 (e.g., following one or more schemes for adjusting repetitions or instances based on bandwidth as described herein).

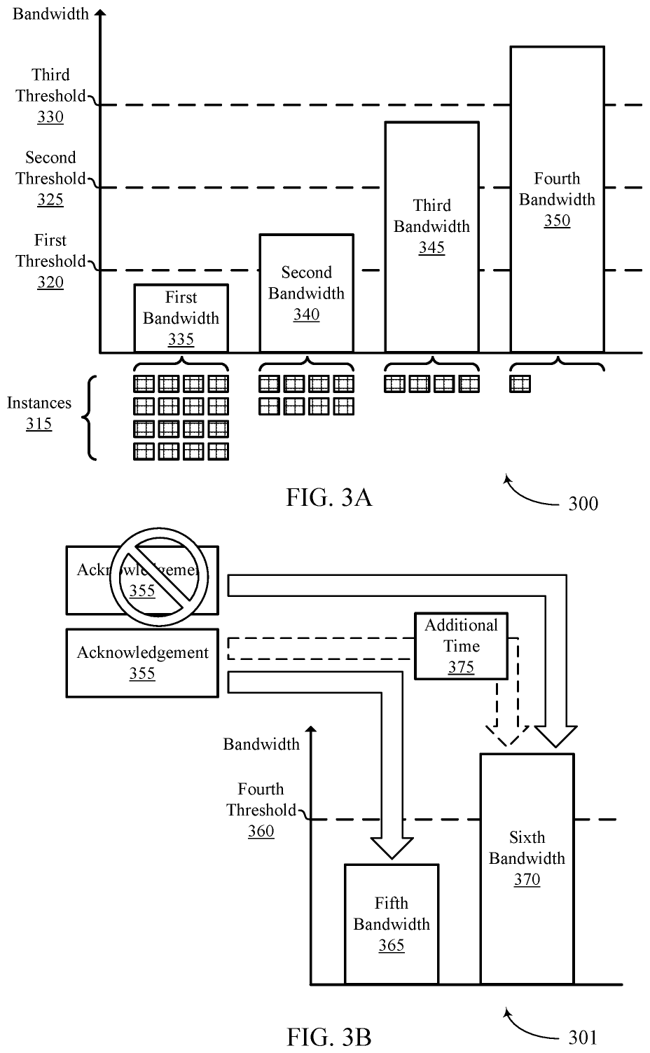

FIGS. 3A and 3B show examples of an MBS scheme 300 and an MBS scheme 301 that support multicast or broadcast operations with enhanced reduced capacity user equipment in accordance with one or more examples as disclosed herein.

The MBS scheme 300 may depict communication scenarios in which a quantity of repetitions or instances of a broadcast or multicast communication (e.g., the MTCH transmission 225) may depend on a bandwidth over which the repetitions or instances are to be transmitted. For example, if the MTCH transmission 225 is to be transmitted over the first bandwidth 335, which falls below the first threshold 320 (e.g., 5 MHz), then a corresponding quantity of instances 315 (e.g., sixteen) may be transmitted. Similarly, if the MTCH transmission 225 is to be transmitted over the second bandwidth 340, which falls above the first threshold 320 (e.g., 5 MHz) and below the second threshold 325 (e.g., 10 MHz), then a corresponding quantity of instances 315 (e.g., eight) may be transmitted. Similarly, if the MTCH transmission 225 is to be transmitted over the third bandwidth 345, which falls above the second threshold 325 (e.g., 10 MHz) and below the third threshold 330 (e.g., 15 MHz), then a corresponding quantity of instances 315 (e.g., four) may be transmitted. Finally, if the MTCH transmission 225 is to be transmitted over the fourth bandwidth 350, which falls above the third threshold 330 (e.g., 15 MHz), then a corresponding quantity of instances 315 (e.g., one) may be transmitted. As shown in the figure, there may be a negative correlation or relationship between the bandwidth (e.g., the first bandwidth 335, the second bandwidth 340, the third bandwidth 345, and the fourth bandwidth 350) and the respective quantities of instances 315 in that a larger bandwidth may be correlated or associated with a smaller quantity of instances 315 and a smaller bandwidth may be correlated or associated with a larger quantity of instances 315.

The MBS scheme 301 may depict communication scenarios in which bandwidths over which a broadcast or multicast communication (e.g., the MTCH transmission 225) is transmitted may depend on whether the UE (e.g., the UE 115-a) is to provide an acknowledgement 355. For example, if the UE is not to provide the acknowledgement 355, then the broadcast or multicast communication may be transmitted over the sixth bandwidth 370 which may exceed the fourth threshold 360 (e.g., 5 MHz). In such a scenario, the UE may expect that the sixth bandwidth 370 is allowed to exceed the fourth threshold 360, though it is not required to do so. However, if the UE is to provide the acknowledgement 355, the broadcast or multicast transmission may be transmitted over the fifth bandwidth 365, which may not exceed the fourth threshold 360 (e.g., 5 MHz). In such a scenario, the UE may expect that the fifth bandwidth 365 is not allowed to exceed the fourth threshold 360.

In some cases, even if the UE is to provide the acknowledgement 355, the UE may determine that the bandwidth (e.g., the sixth bandwidth 370) of the broadcast or multicast transmission may be permitted to exceed the fourth threshold 360. However, if such cases, a network entity may schedule the additional time 375 for the UE to process the larger bandwidth communications and provide the acknowledgement 355 (e.g., which, were the additional time 375 not provided, might fall outside the capabilities of an eRedCap UE). In cases involving such an “exception” where the UE is to provide the acknowledgement 355 and the bandwidth (e.g., the sixth bandwidth) is permitted to exceed a bandwidth threshold (e.g., the fourth threshold 360), a network entity may signal to the UE (e.g., via control signaling or control information) that such a scenario may occur, that the additional time 375 may be provided, or both).

Further, in some cases, if the UE is to provide the acknowledgement 355, the use of multiple repetitions or instances may be enabled or activated, as the fifth bandwidth 365 may not be permitted to exceed the fourth threshold 360, in which case a RedCap UE may be able to receive or process the repetitions given the limited fifth bandwidth. In some cases, if the UE is not to provide the acknowledgement 355, thereby including the possibility of a bandwidth (e.g., the sixth bandwidth 370) exceeding the fourth threshold 360, the quantity of repetitions or instances may depend on or be adjusted based on the amount of bandwidth being used (e.g., as described in relation to FIG. 3A and elsewhere herein).

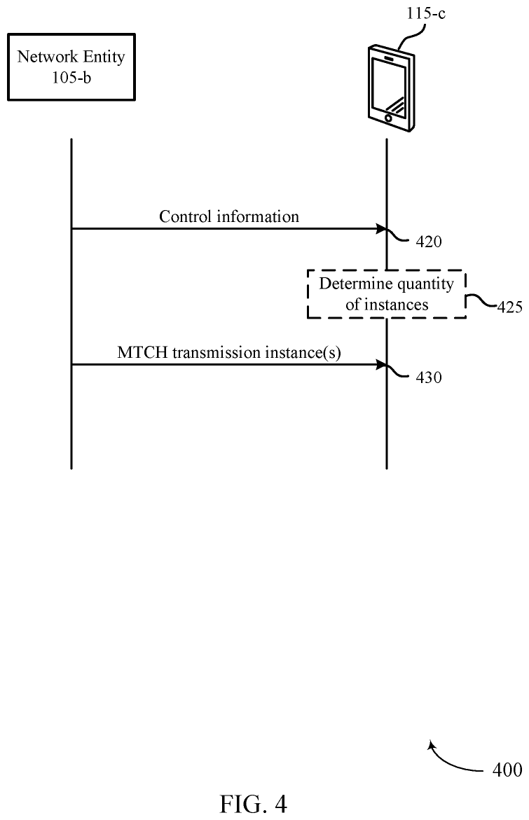

FIG. 4 shows an example of a process flow 400 that supports multicast or broadcast operations with enhanced reduced capacity user equipment in accordance with one or more examples as disclosed herein. The process flow 400 may implement various aspects of the present disclosure described herein. The elements described in the process flow 400 (e.g., the UE 115-c and the network entity 105-b) may be examples of similarly named elements described herein.

In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

At 420, the UE 115-c may receive control information that schedules a multicast traffic channel transmission and that may indicate a bandwidth of the multicast traffic channel transmission. In some examples, the control information is included in downlink control information signaling.

At 425, the UE 115-c may determine the quantity of the one or more instances based on the bandwidth of the multicast traffic channel transmission. In some examples, the UE 115-c may determine the quantity of the one or more instances of the multicast traffic channel transmission based on a comparison of the bandwidth of the multicast traffic channel transmission with a plurality of bandwidth thresholds and each bandwidth threshold may be associated with a respective quantity of supported instances. In some examples, determining the quantity of the one or more instances of the multicast traffic channel transmission may include determining that a first bandwidth threshold of the plurality of bandwidth thresholds is a largest bandwidth threshold satisfied by the bandwidth of the multicast traffic channel transmission.

In some examples, determining the quantity of the one or more instances of the multicast traffic channel transmission may include determining the quantity of the one or more instances of the multicast traffic channel transmission to be the respective quantity of supported instances associated with the first bandwidth threshold. In some examples, the plurality of supported instance quantities may be inversely correlated with the plurality of bandwidth thresholds. In some examples, one of the plurality of bandwidth thresholds may be 5 MHz.

At 430, the UE 115-c may receive, in accordance with the control information, one or more instances, in multiple time slots, of the multicast traffic channel transmission and a quantity of the one or more instances is based on the bandwidth of the multicast traffic channel transmission. In some examples, the bandwidth of the multicast traffic channel transmission is greater than a bandwidth threshold and the quantity of the one or more instances is one. In some examples, the bandwidth of the multicast traffic channel transmission may be less than a bandwidth threshold and the quantity of the one or more instances is two or more. In some examples, the bandwidth threshold may be 5 MHz. In some examples, the multicast traffic channel transmission may be a multicast transmission or a broadcast transmission. In some examples, the multiple time slots may be consecutive time slots or non-consecutive time slots.

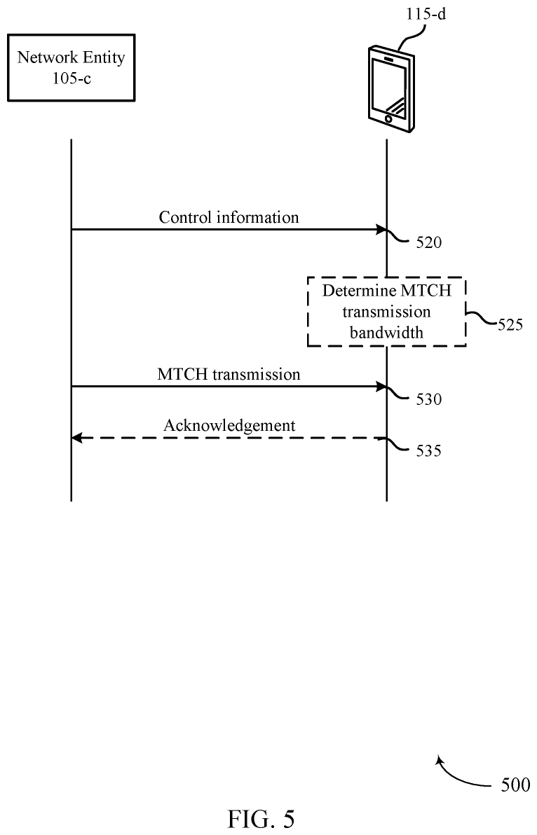

FIG. 5 shows an example of a process flow 500 that supports multicast or broadcast operations with enhanced reduced capacity user equipment in accordance with one or more examples as disclosed herein. The process flow 500 may implement various aspects of the present disclosure described herein. The elements described in the process flow 500 (e.g., UE 115-d and network entity 105-c) may be examples of similarly named elements described herein.

In the following description of the process flow 500, the operations between the various entities or elements may be performed in different orders or at different times. Some operations may also be left out of the process flow 500, or other operations may be added. Although the various entities or elements are shown performing the operations of the process flow 500, some aspects of some operations may also be performed by other entities or elements of the process flow 500 or by entities or elements that are not depicted in the process flow, or any combination thereof.

At 520, the UE 115-d may receive control information that may schedule a multicast traffic channel transmission and that may indicate whether the UE is to transmit an acknowledgement in response to the multicast traffic channel transmission. In some examples, the control information may indicate whether the UE is to transmit an acknowledgement in response to the multicast traffic channel transmission based on an identifier associated with the UE. In some examples, the control information may be included in downlink control information signaling, radio resource control signaling, or both. In some examples, the UE 115-d may be operating in a connected mode.

At 525, the UE 115-d may determine that the bandwidth of the multicast traffic channel transmission is not permitted to exceed a bandwidth threshold based on the control information indicating that the UE is to transmit the acknowledgement in response to the multicast traffic channel transmission. In some examples, the bandwidth threshold is 5 MHz. Additionally, or alternatively, the UE 115-d may determine that the bandwidth of the multicast traffic channel transmission is permitted to exceed a bandwidth threshold based on the control information indicating that the UE is not to transmit the acknowledgement in response to the multicast traffic channel transmission. In some examples, the bandwidth threshold is 5 MHz. Additionally, or alternatively, the UE 115-d may determine that the bandwidth of the multicast traffic channel transmission is permitted to exceed a bandwidth threshold based on the control information indicating that the UE is to transmit the acknowledgement in response to the multicast traffic channel transmission and the control information scheduling second resources for the UE to transmit the acknowledgement that are later in time than first resources scheduled for feedback transmission when the bandwidth of the multicast traffic channel transmission is less than the bandwidth threshold. In some examples, the bandwidth threshold is 5 MHz.

At 530, the UE 115-d may receive, in accordance with the control information, the multicast traffic channel transmission. The multicast traffic channel transmission may be received over a bandwidth that is based on whether the UE is to transmit the acknowledgement in response to the multicast traffic channel transmission.

At 535, the UE 115-d may transmit an acknowledgement (e.g., a positive acknowledgement or a negative acknowledgement). In some examples, the acknowledgement is hybrid automatic repeat request acknowledgement feedback.

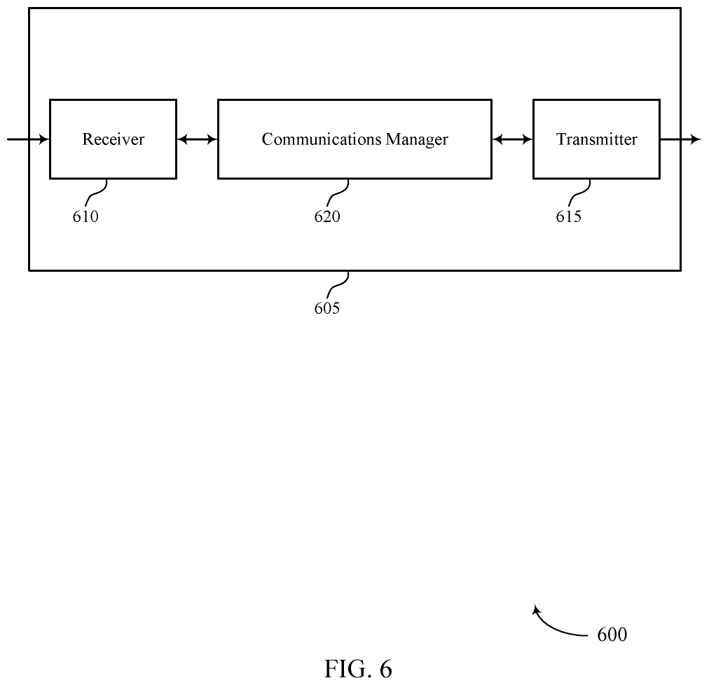

FIG. 6 shows a block diagram 600 of a device 605 that supports multicast or broadcast operations with enhanced reduced capacity user equipment in accordance with one or more examples as disclosed herein. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to support for multicast or broadcast operations with enhanced reduced capacity user equipment). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to support for multicast or broadcast operations with enhanced reduced capacity user equipment). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of support for multicast or broadcast operations with enhanced reduced capacity user equipment as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software) executed by at least one processor. If implemented in code executed by at least one processor, the functions of the communications manager 620, the receiver 610, the transmitter 615, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

Additionally, or alternatively, the communications manager 620 may support wireless communications in accordance with examples as disclosed herein. For example, the communications manager 620 is capable of, configured to, or operable to support a means for receiving control information that schedules a multicast traffic channel transmission and that indicates a bandwidth of the multicast traffic channel transmission. The communications manager 620 is capable of, configured to, or operable to support a means for receiving, in accordance with the control information, one or more instances, in multiple time slots, of the multicast traffic channel transmission, where a quantity of the one or more instances is based on the bandwidth of the multicast traffic channel transmission.

Additionally, or alternatively, the communications manager 620 may support wireless communications in accordance with examples as disclosed herein. For example, the communications manager 620 is capable of, configured to, or operable to support a means for receiving control information that schedules a multicast traffic channel transmission and that indicates whether the UE is to transmit an acknowledgement in response to the multicast traffic channel transmission. The communications manager 620 is capable of, configured to, or operable to support a means for receiving, in accordance with the control information, the multicast traffic channel transmission, where the multicast traffic channel transmission is received over a bandwidth that is based on whether the UE is to transmit the acknowledgement in response to the multicast traffic channel transmission.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, more efficient utilization of communication resources, or any combination thereof.

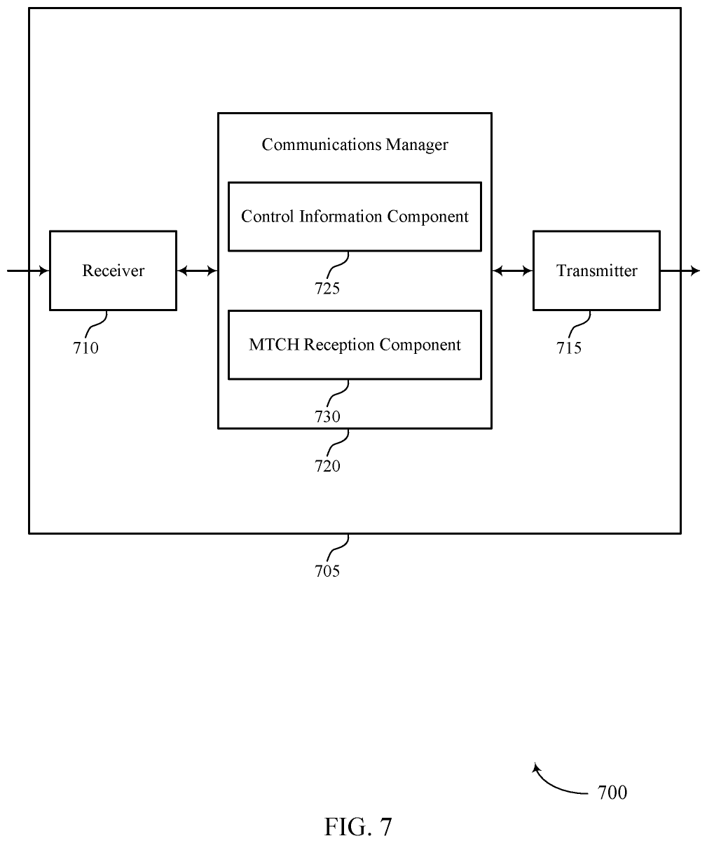

FIG. 7 shows a block diagram 700 of a device 705 that supports multicast or broadcast operations with enhanced reduced capacity user equipment in accordance with one or more examples as disclosed herein. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to support for multicast or broadcast operations with enhanced reduced capacity user equipment). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to support for multicast or broadcast operations with enhanced reduced capacity user equipment). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of support for multicast or broadcast operations with enhanced reduced capacity user equipment as described herein. For example, the communications manager 720 may include a control information component 725 an MTCH reception component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The control information component 725 is capable of, configured to, or operable to support a means for receiving control information that schedules a multicast traffic channel transmission and that indicates a bandwidth of the multicast traffic channel transmission. The MTCH reception component 730 is capable of, configured to, or operable to support a means for receiving, in accordance with the control information, one or more instances, in multiple time slots, of the multicast traffic channel transmission, where a quantity of the one or more instances is based on the bandwidth of the multicast traffic channel transmission.

Additionally, or alternatively, the communications manager 720 may support wireless communications in accordance with examples as disclosed herein. The control information component 725 is capable of, configured to, or operable to support a means for receiving control information that schedules a multicast traffic channel transmission and that indicates whether the UE is to transmit an acknowledgement in response to the multicast traffic channel transmission. The MTCH reception component 730 is capable of, configured to, or operable to support a means for receiving, in accordance with the control information, the multicast traffic channel transmission, where the multicast traffic channel transmission is received over a bandwidth that is based on whether the UE is to transmit the acknowledgement in response to the multicast traffic channel transmission.

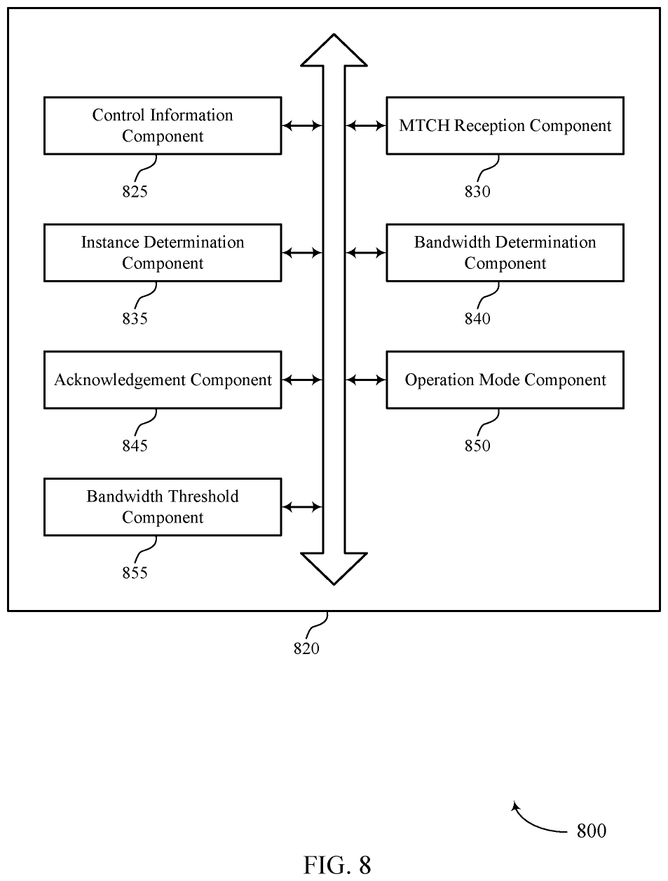

FIG. 8 shows a block diagram 800 of a communications manager 820 that supports multicast or broadcast operations with enhanced reduced capacity user equipment in accordance with one or more examples as disclosed herein. The communications manager 820 may be an example of aspects of a communications manager 620, a communications manager 720, or both, as described herein. The communications manager 820, or various components thereof, may be an example of means for performing various aspects of support for multicast or broadcast operations with enhanced reduced capacity user equipment as described herein. For example, the communications manager 820 may include a control information component 825, an MTCH reception component 830, an instance determination component 835, a bandwidth determination component 840, an acknowledgement component 845, an operation mode component 850, a bandwidth threshold component 855, or any combination thereof. Each of these components, or components or subcomponents thereof (e.g., one or more processors, one or more memories), may communicate, directly or indirectly, with one another (e.g., via one or more buses).

Additionally, or alternatively, the communications manager 820 may support wireless communications in accordance with examples as disclosed herein. The control information component 825 is capable of, configured to, or operable to support a means for receiving control information that schedules a multicast traffic channel transmission and that indicates a bandwidth of the multicast traffic channel transmission. The MTCH reception component 830 is capable of, configured to, or operable to support a means for receiving, in accordance with the control information, one or more instances, in multiple time slots, of the multicast traffic channel transmission, where a quantity of the one or more instances is based on the bandwidth of the multicast traffic channel transmission.

In some examples, the instance determination component 835 is capable of, configured to, or operable to support a means for determining the quantity of the one or more instances based on the bandwidth of the multicast traffic channel transmission.

In some examples, the instance determination component 835 is capable of, configured to, or operable to support a means for determining the quantity of the one or more instances of the multicast traffic channel transmission based on a comparison of the bandwidth of the multicast traffic channel transmission with a set of multiple bandwidth thresholds, where each bandwidth threshold is associated with a respective quantity of supported instances.

In some examples, to support determining the quantity of the one or more instances of the multicast traffic channel transmission, the bandwidth determination component 840 is capable of, configured to, or operable to support a means for determining that a first bandwidth threshold of the set of multiple bandwidth thresholds is a largest bandwidth threshold satisfied by the bandwidth of the multicast traffic channel transmission. In some examples, to support determining the quantity of the one or more instances of the multicast traffic channel transmission, the instance determination component 835 is capable of, configured to, or operable to support a means for determining the quantity of the one or more instances of the multicast traffic channel transmission to be the respective quantity of supported instances associated with the first bandwidth threshold.

In some examples, the set of multiple supported instance quantities is inversely correlated with the set of multiple bandwidth thresholds. In some examples, one of the set of multiple bandwidth thresholds is 5 MHz. In some examples, the bandwidth of the multicast traffic channel transmission is greater than a bandwidth threshold. In some examples, the quantity of the one or more instances is one. In some examples, the bandwidth threshold is 5 MHz. In some examples, the bandwidth of the multicast traffic channel transmission is less than a bandwidth threshold. In some examples, the quantity of the one or more instances is two or more. In some examples, the bandwidth threshold is 5 MHz. In some examples, the control information is included in downlink control information signaling. In some examples, the multicast traffic channel transmission is a multicast transmission or a broadcast transmission. In some examples, the multiple time slots are consecutive time slots or non-consecutive time slots.

Additionally, or alternatively, the communications manager 820 may support wireless communications in accordance with examples as disclosed herein. In some examples, the control information component 825 is capable of, configured to, or operable to support a means for receiving control information that schedules a multicast traffic channel transmission and that indicates whether the UE is to transmit an acknowledgement in response to the multicast traffic channel transmission. In some examples, the MTCH reception component 830 is capable of, configured to, or operable to support a means for receiving, in accordance with the control information, the multicast traffic channel transmission, where the multicast traffic channel transmission is received over a bandwidth that is based on whether the UE is to transmit the acknowledgement in response to the multicast traffic channel transmission.

In some examples, the bandwidth determination component 840 is capable of, configured to, or operable to support a means for determining that the bandwidth of the multicast traffic channel transmission is not permitted to exceed a bandwidth threshold based on the control information indicating that the UE is to transmit the acknowledgement in response to the multicast traffic channel transmission. In some examples, the bandwidth threshold is 5 MHz.

In some examples, the bandwidth determination component 840 is capable of, configured to, or operable to support a means for determining that the bandwidth of the multicast traffic channel transmission is permitted to exceed a bandwidth threshold based on the control information indicating that the UE is not to transmit the acknowledgement in response to the multicast traffic channel transmission. In some examples, the bandwidth threshold is 5 MHz.

In some examples, the acknowledgement component 845 is capable of, configured to, or operable to support a means for determining that the bandwidth of the multicast traffic channel transmission is permitted to exceed a bandwidth threshold based on the control information indicating that the UE is to transmit the acknowledgement in response to the multicast traffic channel transmission and the control information scheduling second resources for the UE to transmit the acknowledgement that are later in time than first resources scheduled for feedback transmission when the bandwidth of the multicast traffic channel transmission is less than the bandwidth threshold.

In some examples, the control information indicates whether the UE is to transmit an acknowledgement in response to the multicast traffic channel transmission based on an identifier associated with the UE. In some examples, the acknowledgement is hybrid automatic repeat request acknowledgement feedback. In some examples, the UE is operating in a connected mode. In some examples, the control information is included in downlink control information signaling, radio resource control signaling, or both.

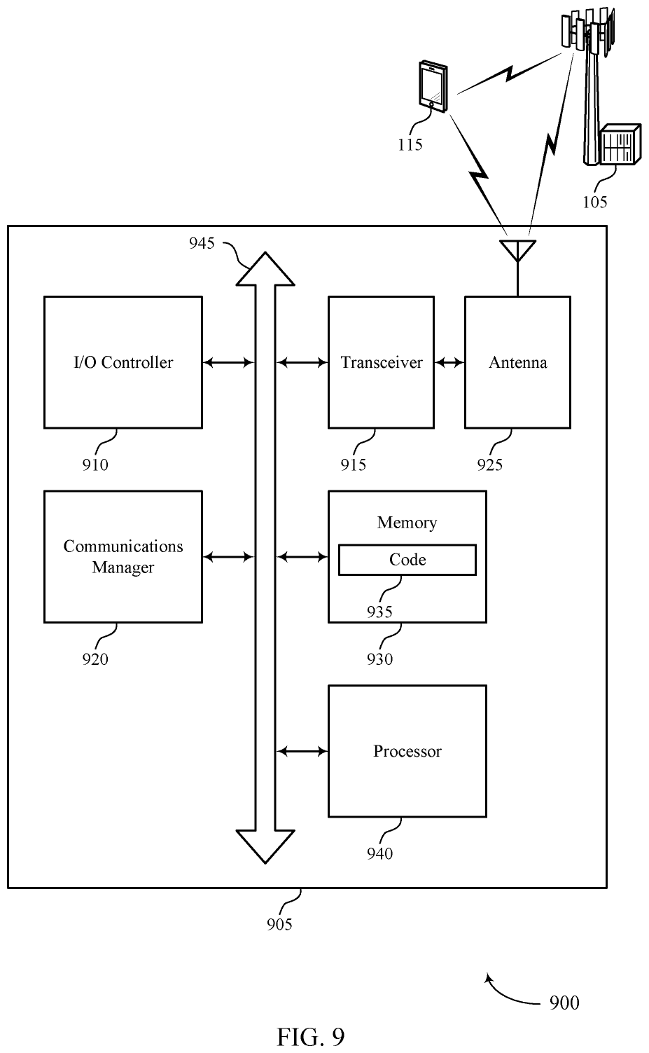

FIG. 9 shows a diagram of a system 900 including a device 905 that supports multicast or broadcast operations with enhanced reduced capacity user equipment in accordance with one or more examples as disclosed herein. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting support for multicast or broadcast operations with enhanced reduced capacity user equipment). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein.

Additionally, or alternatively, the communications manager 920 may support wireless communications in accordance with examples as disclosed herein. For example, the communications manager 920 is capable of, configured to, or operable to support a means for receiving control information that schedules a multicast traffic channel transmission and that indicates a bandwidth of the multicast traffic channel transmission. The communications manager 920 is capable of, configured to, or operable to support a means for receiving, in accordance with the control information, one or more instances, in multiple time slots, of the multicast traffic channel transmission, where a quantity of the one or more instances is based on the bandwidth of the multicast traffic channel transmission.

Additionally, or alternatively, the communications manager 920 may support wireless communications in accordance with examples as disclosed herein. For example, the communications manager 920 is capable of, configured to, or operable to support a means for receiving control information that schedules a multicast traffic channel transmission and that indicates whether the UE is to transmit an acknowledgement in response to the multicast traffic channel transmission. The communications manager 920 is capable of, configured to, or operable to support a means for receiving, in accordance with the control information, the multicast traffic channel transmission, where the multicast traffic channel transmission is received over a bandwidth that is based on whether the UE is to transmit the acknowledgement in response to the multicast traffic channel transmission.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of support for multicast or broadcast operations with enhanced reduced capacity user equipment as described herein, or the at least one processor 940 and the at least one memory 930 may be otherwise configured to, individually or collectively, perform or support such operations.

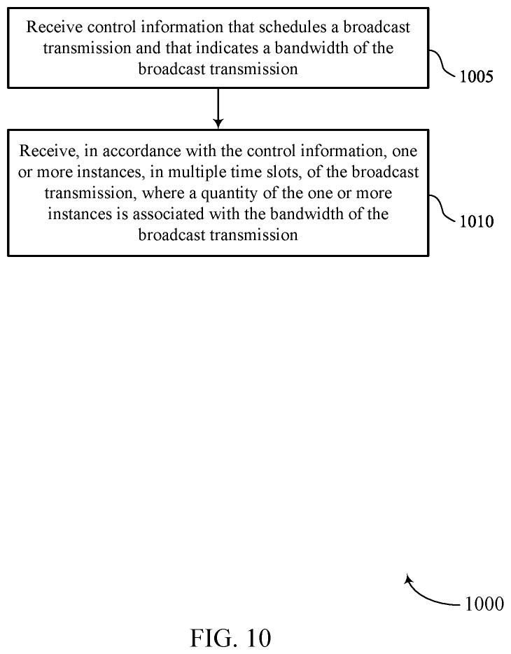

FIG. 10 shows a flowchart illustrating a method 1000 that supports multicast or broadcast operations with enhanced reduced capacity user equipment in accordance with examples as disclosed herein. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving control information that schedules a broadcast transmission and that indicates a bandwidth of the broadcast transmission. The operations of block 1005 may be performed in accordance with examples as disclosed herein. In some examples, aspects of the operations of 1005 may be performed by a control information component 825 as described with reference to FIG. 8.

At 1010, the method may include receiving, in accordance with the control information, one or more instances, in multiple time slots, of the broadcast transmission, where a quantity of the one or more instances is associated with the bandwidth of the broadcast transmission. The operations of block 1010 may be performed in accordance with examples as disclosed herein. In some examples, aspects of the operations of 1010 may be performed by an MTCH reception component 830 as described with reference to FIG. 8.

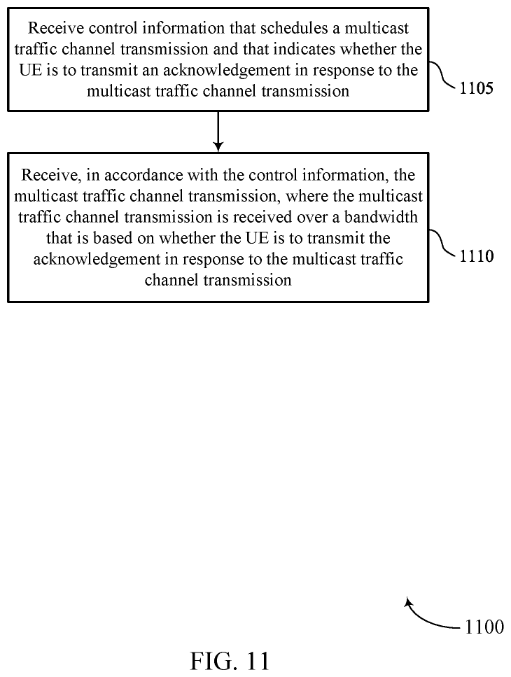

FIG. 11 shows a flowchart illustrating a method 1100 that supports multicast or broadcast operations with enhanced reduced capacity user equipment in accordance with examples as disclosed herein. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving control information that schedules a multicast traffic channel transmission and that indicates whether the UE is to transmit an acknowledgement in response to the multicast traffic channel transmission. The operations of block 1105 may be performed in accordance with examples as disclosed herein. In some examples, aspects of the operations of 1105 may be performed by a control information component 825 as described with reference to FIG. 8.

At 1110, the method may include receiving, in accordance with the control information, the multicast traffic channel transmission, where the multicast traffic channel transmission is received over a bandwidth that is based on whether the UE is to transmit the acknowledgement in response to the multicast traffic channel transmission. The operations of block 1110 may be performed in accordance with examples as disclosed herein. In some examples, aspects of the operations of 1110 may be performed by an MTCH reception component 830 as described with reference to FIG. 8.

The following provides an overview of aspects of the present disclosure:
Aspect 1: A method for wireless communications at a UE, comprising: receiving control information that schedules a broadcast transmission and that indicates a bandwidth of the broadcast transmission; and receiving, in accordance with the control information, one or more instances, in multiple time slots, of the broadcast transmission, wherein a quantity of the one or more instances is based at least in part on the bandwidth of the broadcast transmission.
Aspect 2: The method of aspect 1, wherein the bandwidth of the broadcast transmission being greater than a bandwidth threshold is associated with the quantity of the one or more instances being one, and wherein the bandwidth of the broadcast transmission being less than the bandwidth threshold is associated with the quantity of the one or more instances being two or more.
Aspect 3: The method of aspect 2, wherein the bandwidth threshold is 5 MHz.
Aspect 4: The method of any of aspects 2 through 3, wherein the bandwidth threshold is based at least in part on 25 physical resource blocks and a subcarrier spacing of 15 kHz or 12 physical resource blocks and a subcarrier spacing of 30 kHz.
Aspect 5: The method of any of aspects 1 through 4, wherein the bandwidth of the broadcast transmission indicates the quantity of the one or more instances to be processed by the UE.
Aspect 6: The method of any of aspects 1 through 5, wherein the bandwidth of the broadcast transmission is less than a bandwidth threshold, wherein the one or more instances comprises a plurality of instances based at least in part on the bandwidth of the broadcast traffic channel transmission being less than a bandwidth threshold, and wherein the method further comprises: processing the plurality of instances based at least in part on the bandwidth of the broadcast transmission being less than the bandwidth threshold.
Aspect 7: The method of any of aspects 1 through 2, further comprising: determining the quantity of the one or more instances of the broadcast transmission based at least in part on a comparison of the bandwidth of the broadcast transmission with a plurality of bandwidth thresholds, wherein each bandwidth threshold is associated with a respective quantity of supported instances.
Aspect 8: The method of aspect 3, wherein determining the quantity of the one or more instances of the broadcast transmission further comprises: determining that a first bandwidth threshold of the plurality of bandwidth thresholds is a largest bandwidth threshold satisfied by the bandwidth of the broadcast transmission; and determining the quantity of the one or more instances of the broadcast transmission to be the respective quantity of supported instances associated with the first bandwidth threshold.
Aspect 9: The method of any of aspects 3 through 4, wherein the plurality of supported instance quantities is inversely correlated with the plurality of bandwidth thresholds.
Aspect 10: The method of any of aspects 3 through 5, wherein one of the plurality of bandwidth thresholds is 5 MHz.
Aspect 11: The method of any of aspects 1 through 10, wherein the control information is included in downlink control information signaling.
Aspect 12: The method of any of aspects 1 through 11, wherein the multiple time slots are consecutive time slots or non-consecutive time slots.
Aspect 13: A method for wireless communications at a UE, comprising: receiving control information that schedules a multicast traffic channel transmission and that indicates whether the UE is to transmit an acknowledgement in response to the multicast traffic channel transmission; and receiving, in accordance with the control information, the multicast traffic channel transmission, wherein the multicast traffic channel transmission is received over a bandwidth that is based at least in part on whether the UE is to transmit the acknowledgement in response to the multicast traffic channel transmission.
Aspect 14: The method of aspect 13, further comprising: determining that the bandwidth of the multicast traffic channel transmission is not permitted to exceed a bandwidth threshold based at least in part on the control information indicating that the UE is to transmit the acknowledgement in response to the multicast traffic channel transmission.
Aspect 15: The method of aspect 14, wherein the bandwidth threshold is 5 MHz.
Aspect 16: The method of any of aspects 13 through 15, further comprising: determining that the bandwidth of the multicast traffic channel transmission is permitted to exceed a bandwidth threshold based at least in part on the control information indicating that the UE is not to transmit the acknowledgement in response to the multicast traffic channel transmission.
Aspect 17: The method of aspect 16, wherein the bandwidth threshold is 5 MHz.
Aspect 18: The method of any of aspects 13 through 17, further comprising: determining that the bandwidth of the multicast traffic channel transmission is permitted to exceed a bandwidth threshold based at least in part on the control information indicating that the UE is to transmit the acknowledgement in response to the multicast traffic channel transmission and the control information scheduling second resources for the UE to transmit the acknowledgement that are later in time than first resources scheduled for feedback transmission when the bandwidth of the multicast traffic channel transmission is less than the bandwidth threshold.
Aspect 19: The method of any of aspects 13 through 18, wherein the control information indicates whether the UE is to transmit an acknowledgement in response to the multicast traffic channel transmission based at least in part on an identifier associated with the UE.
Aspect 20: The method of any of aspects 13 through 19, wherein the acknowledgement is hybrid automatic repeat request acknowledgement feedback.
Aspect 21: The method of any of aspects 13 through 20, wherein the UE is operating in a connected mode.
Aspect 22: The method of any of aspects 13 through 21, wherein the control information is included in downlink control information signaling, radio resource control signaling, or both.
Aspect 23: A UE for wireless communications, comprising one or more memories storing processor-executable code, and one or more processors coupled with the one or more memories and individually or collectively operable to execute the code to cause the UE to perform a method of any of aspects 1 through 12.
Aspect 24: A UE for wireless communications, comprising at least one means for performing a method of any of aspects 1 through 12.
Aspect 25: A non-transitory computer-readable medium storing code for wireless communications, the code comprising instructions executable by a processor to perform a method of any of aspects 1 through 12.
Aspect 26: A UE for wireless communications, comprising one or more memories storing processor-executable code, and one or more processors coupled with the one or more memories and individually or collectively operable to execute the code to cause the UE to perform a method of any of aspects 13 through 22.
Aspect 27: A UE for wireless communications, comprising at least one means for performing a method of any of aspects 13 through 22.
Aspect 28: A non-transitory computer-readable medium storing code for wireless communications, the code comprising instructions executable by a processor to perform a method of any of aspects 13 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control information that schedules a broadcast transmission and that indicates a bandwidth of the broadcast transmission; and
receive, in accordance with the control information, one or more instances, in multiple time slots, of the broadcast transmission, wherein a quantity of the one or more instances is associated with the bandwidth of the broadcast transmission.

2. The UE of claim 1, wherein:
the bandwidth of the broadcast transmission being greater than a bandwidth threshold is associated with the quantity of the one or more instances being one; and
the bandwidth of the broadcast transmission being less than the bandwidth threshold is associated with the quantity of the one or more instances being two or more.

3. The UE of claim 2, wherein:
the bandwidth threshold is 5 MHz.

4. The UE of claim 2, wherein:
the bandwidth threshold is based at least in part on 25 physical resource blocks and a subcarrier spacing of 15 kHz or 12 physical resource blocks and a subcarrier spacing of 30 kHz.

5. The UE of claim 1, wherein the bandwidth of the broadcast transmission indicates the quantity of the one or more instances to be processed by the UE.

6. The UE of claim 1, wherein the bandwidth of the broadcast transmission is less than a bandwidth threshold, wherein the one or more instances comprises a plurality of instances based at least in part on the bandwidth of the broadcast transmission being less than the bandwidth threshold, and wherein the one or more processors are individually or collectively further operable to execute the code to cause the UE to:
process the plurality of instances based at least in part on the bandwidth of the broadcast transmission being less than the bandwidth threshold.

7. The UE of claim 1, wherein the one or more processors are individually or collectively further operable to execute the code to cause the UE to:
determine the quantity of the one or more instances of the broadcast transmission based at least in part on a comparison of the bandwidth of the broadcast transmission with a plurality of bandwidth thresholds, wherein each bandwidth threshold is associated with a respective quantity of supported instances.

8. The UE of claim 7, wherein, to determine the quantity of the one or more instances of the broadcast transmission, the one or more processors are individually or collectively further operable to execute the code to cause the UE to:
determine that a first bandwidth threshold of the plurality of bandwidth thresholds is a largest bandwidth threshold satisfied by the bandwidth of the broadcast transmission; and
determine the quantity of the one or more instances of the broadcast transmission to be the respective quantity of supported instances associated with the first bandwidth threshold.

9. The UE of claim 7, wherein the quantities of supported instances are inversely correlated with the plurality of bandwidth thresholds.

10. The UE of claim 7, wherein:
one of the plurality of bandwidth thresholds is 5 MHz.

11. A user equipment (UE), comprising:
one or more memories storing processor-executable code; and
one or more processors coupled with the one or more memories and individually or collectively operable to execute the code to cause the UE to:
receive control information that schedules a multicast traffic channel transmission and that indicates whether the UE is to transmit an acknowledgement in response to the multicast traffic channel transmission; and
receive, in accordance with the control information, the multicast traffic channel transmission, wherein the multicast traffic channel transmission is received over a bandwidth that is based at least in part on whether the UE is to transmit the acknowledgement in response to the multicast traffic channel transmission.

12. The UE of claim 11, wherein the one or more processors are individually or collectively further operable to execute the code to cause the UE to:
determine that the bandwidth of the multicast traffic channel transmission is not permitted to exceed a bandwidth threshold based at least in part on the control information indicating that the UE is to transmit the acknowledgement in response to the multicast traffic channel transmission.

13. The UE of claim 12, wherein:
the bandwidth threshold is 5 MHz.

14. The UE of claim 11, wherein the one or more processors are individually or collectively further operable to execute the code to cause the UE to:
determine that the bandwidth of the multicast traffic channel transmission is permitted to exceed a bandwidth threshold based at least in part on the control information indicating that the UE is not to transmit the acknowledgement in response to the multicast traffic channel transmission.

15. The UE of claim 14, wherein:
the bandwidth threshold is 5 MHz.

16. The UE of claim 11, wherein the one or more processors are individually or collectively further operable to execute the code to cause the UE to:
determine that the bandwidth of the multicast traffic channel transmission is permitted to exceed a bandwidth threshold based at least in part on the control information indicating that the UE is to transmit the acknowledgement in response to the multicast traffic channel transmission and the control information scheduling second resources for the UE to transmit the acknowledgement that are later in time than first resources scheduled for feedback transmission when the bandwidth of the multicast traffic channel transmission is less than the bandwidth threshold.

17. The UE of claim 11, wherein the control information indicates whether the UE is to transmit the acknowledgement in response to the multicast traffic channel transmission based at least in part on an identifier associated with the UE.

18. The UE of claim 11, wherein:
the acknowledgement is hybrid automatic repeat request acknowledgement feedback.

19. The UE of claim 11, wherein the UE is operating in a connected mode.

20. A method for wireless communications at a user equipment (UE), comprising:
receiving control information that schedules a broadcast transmission and that indicates a bandwidth of the broadcast transmission; and
receiving, in accordance with the control information, one or more instances, in multiple time slots, of the broadcast transmission, wherein a quantity of the one or more instances is associated with the bandwidth of the broadcast transmission.
